(19) United States
(12) Patent Application Publication
(10) Pub. No.: US 2004/0056947 A1
(43) Pub. Date: Mar. 25, 2004

(54) Image processsing apparatus

(75) Inventor: Roger S. Kerr, Brockport, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/252,315

(22) Filed: Sep. 23, 2002

(51) Int. Cl. B41J 2/435; G01D 15/24; G01D 15/26

(52) U.S. Cl. 347/262; 347/264; 346/138

(57) ABSTRACT

The invention provides an imaging drum (300) for an imaging apparatus, the imaging drum being provided with a recess (326) for receiving an image media. The recess is defined by one or more openings of a mask coupled to the drum. The invention also provides a method of making an imaging drum for use in an imaging apparatus. The method comprises the steps of providing a drum, applying a mask to the drum (300), the mask pattern being formed of a material having a thickness sufficient to define a recess of a desired depth on the drum surface when the mask is applied to the drum.

### FIELD OF THE INVENTION

The present invention relates to an improved imaging drum for use in an image processing apparatus and to an image processing apparatus incorporating the improved drum. The invention also relates to a kit for making the improved drum.

### BACKGROUND OF THE INVENTION

Pre-press proofing is a procedure that is used primarily by the printing industry for creating representative images of printed material. In the printing industry pre-press color proofs are used to check for color balance, control parameters and other important image quality requirements, without the cost and time that is required to actually produce printing plates, set up a printing press and produce an example of a representative image, which would result in higher costs and loss of profit that would ultimately be passed on to the customer.

To form a pre-press proof an original image is separated into individual color separations or digital files. The original image is scanned and separated into the three subtractive primaries and black. Typically a color scanner is used to create the color separations or digital files and in some instances, more than four color separations or digital files are used. Although there are several ways used in the printing industry to create a pre-press proof from the color separations or digital files they are generally one of three types. The first method being a color overlay system that employs the representative image on a separate base for each color, which are then overlaid to create a pre-press proof. The second, a single integral sheet process in which the separate colors for the representative image are transferred one at a time by lamination onto a single base. Third, a digital method in which the representative image is produced directly onto a receiver stock, or onto an intermediate sheet then transferred by lamination onto a receiver stock from digital files.

The representative image to be laminated can be created on, for example, a commercially available Kodak image processing apparatus, depicted in commonly assigned U.S. Pat. No. 5,268,708, which describes an image processing apparatus having half-tone color imaging capabilities. The above-mentioned image processing apparatus is arranged to form a representative image onto a sheet of thermal print media in which colorant from a sheet of colorant donor material is transferred to the thermal print media, by applying a sufficient amount of thermal energy to the colorant donor sheet material to form the representative image. The image processing apparatus is comprised generally of, a material supply, media exit transports and a lathe bed scanning subsystem. The lathe bed scanning subsystem includes: a lathe bed scanning frame, translation drive, translation stage member, printhead and an imaging drum with a radial recess. The radial recess is used in the alignment of the media on the imaging drum.

The operation of the image processing apparatus comprises of metering a length of the thermal print media (in roll form) from the material supply assembly. The thermal print media is then measured and cut into sheet form of the required length and transported to the imaging drum, registered, wrapped around, and secured onto the imaging drum within a radial image recess. Next a length of colorant donor material (in roll form) is also metered out of the material supply assembly, then measured and cut into sheet form of the required length. It is then transported to the imaging drum. Wrapped around the imaging drum utilizing a load roller which is described in detail, in commonly assigned U.S. Pat. No. 5,268,708, such that it is superposed in the desired registration with respect to the thermal print media (which has already been secured to the imaging drum).

After the colorant donor sheet material is secured to the periphery of the imaging drum, the scanning subsystem or write engine provides the imaging function. This image function is accomplished by retaining the thermal print media and the colorant donor sheet material on the imaging drum while it is rotated past the printhead. The translation drive traverses the printhead and translation stage member axially along the axis of the imaging drum, in coordinated motion with the rotating imaging drum. These movements combine to produce the representative image on the thermal print media.

Once the representative image has been formed on the thermal print media, the colorant donor sheet material is then removed from the imaging drum. This is accomplished without disturbing the thermal print media that is beneath it. The colorant donor sheet material is then transported out of the image processing apparatus by means of the material exit transport. Additional colorant donor sheet materials featuring other desired colorants are sequentially superimposed with the thermal print media on the imaging drum and then imaged onto the thermal print media as previously mentioned, until the representative image is completed on the thermal print media. The representative image formed thereon is then unloaded from the imaging drum and transported by the receiver sheet material exit transport to an exit tray in the exterior of the image processing apparatus.

After a representative image has been formed on the thermal print media as previously described it is transferred to a receiver to create a pre-press proof representative of the image that will be printed by the printing press. The receiver stock can be sheet-fed press printing stock, specially coated paper stock, previously laminated stock or any other suitable material.

It should be noted that the above described imaging method works well for most materials and may utilize thermal, ink jet or a combination of both to form a pre-press proof.

Although the presently known and utilized image processing apparatus is satisfactory, a need exists to improve the imaging drum and in particular the radial image recess on the surface of the imaging drum.

Conventionally, to obtain the recess on the imaging drum, it is necessary to machine the recess using precision machining apparatus. This is expensive and time consuming. In addition, when transferring an image onto the media using the imaging drum and a printhead assembly, the light used to enact the transfer has a small depth of focus, typically of the order of 40 μm. The tolerance of the variation in depth of the recess is extremely small and is therefore difficult to achieve. The tolerance of the print head to the imaging drum is typically approximately 110 μm.

### SUMMARY OF THE INVENTION

According to one aspect of the present invention, there is provided an imaging drum for an imaging apparatus. The imaging drum is provided with a recess for receiving an image media, the recess being defined by one or more openings of a mask coupled to the drum. The mask may be coupled to the drum using any suitable coupling means e.g. adhesive applied on one side of the mask or magnetic couplers positioned to maintain the mask in position on the drum. A vacuum may also be used.

Preferably, the drum is cylindrical and the mask is a substantially rectangular frame, such that when in position on the drum, the mask defines a recess. Alternatively, the drum may be octagonal or heptagonal or any other suitable shape.

A further aspect of the present invention comprises a kit for assembling an imaging drum. The kit includes a drum e.g. a cylindrical drum, and a mask. The mask has at least one opening and is formed of a material having a thickness sufficient to define the desired depth of a recess formed on the drum when it is applied to the cylindrical drum.

Preferably, the mask is formed from material having one side coated with adhesive such that the mask is easily adhered to the cylindrical drum. Adhesive is not essential since different ways of coupling the mask to the drum may be utilized. For example, magnetics could be used.

More preferably, the mask is formed of a material selected from the group consisting of polyurethane, vinyl, acetate, metallic film. Any other suitable material may be used so long as it is strong enough to perform the function of the mask and flexible enough to conform accurately to the surface of the drum.

In one example, the mask comprises elongate rectangular members i.e. strips, for positioning circumferentially at opposite ends of the cylindrical drum. When in position, the strips will define a radial recess on the drum surface.

In an alternative example, instead of (or as well as) comprising openings, the mask comprises a planar sheet of material having a recessed rectangular portion to define the recess on the drum surface when in position.

Preferably, in all cases, one or more vent holes are provided in the mask to enable communication between the drum and a layer of material applied on the mask. These enable communication between the vacuum which may exist within the drum and any further layers e.g. colorant donor material, positioned on top of the thermal print media during printing.

One aspect of the invention provides a mask for application to an imaging drum. In a preferred example, the mask has at least one opening, such that when the mask is applied to an imaging drum the at least one opening defines a recess on the drum surface, and wherein the thickness of the mask is selected to correspond to the desired depth of the recess.

Preferably, the mask is formed of a material selected from the group consisting of polyurethane, vinyl, acetate, metallic film or any other suitable material. More preferably, the mask is made of a material such as peel and stick adhesive.

The mask may comprise a substantially rectangular frame (e.g. four sided or U-shaped) having one dimension equal in length to the length of the drum to which it is to be applied and one dimension equal in length to the circumference of the drum to which it is to be applied.

In an alternative example, the mask comprises a sheet of the material having a recessed rectangular portion, the recessed rectangular portion defining a recess on the drum surface when the mask is applied to an imaging drum.

It is preferred that the mask is provided with a pressure sensitive adhesive on one side thereof to enable adherence of the mask to the drum.

According to a further aspect of the present invention, there is provided an imaging apparatus, comprising an imaging drum according to the first aspect of the present invention, for receiving thermal print media and at least one colorant donor material. The apparatus also includes a writer to write an image onto the thermal print media.

A further aspect of the present invention provides a method of making an imaging drum for use in an imaging apparatus. The method comprises the steps of providing a cylindrical drum and applying a mask to the drum. The mask is formed of a material having a thickness sufficient to define a recess of a desired depth on the drum surface when applied to the cylindrical drum. Preferably, the mask is made of a material such as peel and stick adhesive.

The present invention provides an image processing apparatus and an imaging drum with an improved image recess on the surface of the drum. This serves to reduce the cost of the imaging drum at the same time reducing the chance of media fly-off that can cause a catastrophic failure of the imaging apparatus. Since the recess in the drum is provided by openings in a mask applied to the drum, there is no requirement to machine the recess directly in the surface of the drum. This substantially reduces the cost and complexity of making such a drum. Furthermore, the depth of the recess is defined by the thickness of the mask. This is easily controlled enabling precise depths of recesses to be easily achieved.

### BRIEF DESCRIPTION OF THE DRAWINGS

Examples of the present invention will now be described in detail with reference to the accompanying drawings, in which:

FIG. 1 is a schematic view of a section through an image processing apparatus according to one aspect of the present invention;

FIG. 2 is a perspective view of an imaging drum for use in the apparatus shown in FIG. 1;

FIG. 3 is a plan view of a vacuum imaging drum surface according to the present invention;

FIGS. 4A to 4C are plan views of a vacuum imaging drum according to the present invention, showing a sequence of placement for thermal print media and dye donor sheet material;

FIGS. 5A to 5C are plane views of masks according to one aspect of the present invention;

FIG. 6A shows an alternative example of a mask according to the present invention;

FIG. 6B shows a section through the line II in the mask of FIG. 6A; and

FIG. 7 shows a section through a mask according to the present invention.

### DETAILED DESCRIPTION OF THE INVENTION

The present invention will be directed, in particular, to elements forming part of, or cooperating more directly with an apparatus in accordance with the present invention. It is to be understood that elements not specifically shown or described may take various forms well known to those skilled in the art. For the sake of discussion, but not limitation, the preferred embodiment of the present invention will be illustrated in relation to an image processing apparatus for making pre-press proofs.

In the following description, like reference characters designate like or corresponding parts throughout the several views. Also, in the following description, it is to be understood that such terms as “front,” “rear,” “lower,” “upper,” and the like are words of convenience and are not to be construed as limiting terms. Referring in more detail to the drawings, the invention will now be described.

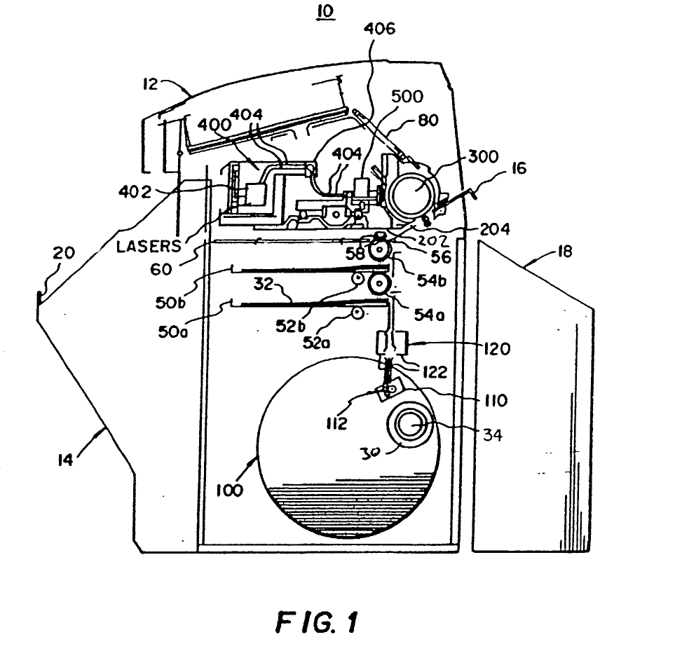

Referring to FIG. 1, an image processing apparatus according to one aspect of the present invention, which is generally referred to as 10, includes an image processor housing 12, which provides a protective cover for the apparatus. The apparatus 10 also includes a hinged image processor door 14, which is attached to the front portion of the image processor housing 12 and permits access to the media carousel 100 and the two sheet material trays. A lower sheet thermal print material tray 50a and upper sheet input image material tray 50b are positioned in the interior portion of the image processor housing 12 for supporting thermal print media 32, or an input image, thereon. Only one of the sheet material trays 50 will dispense the thermal print media 32 out of the sheet material tray 50 to create an intended image thereon. The alternate sheet material tray either holds an alternative type of thermal print media 32, or an input image, or functions as a back up sheet material tray. In this regard, lower sheet material tray 50a includes a lower media lift cam 52a, which is used to lift the lower sheet material tray 50a and, ultimately, the thermal print media 32 upwardly toward lower media roller 54a and upper media roller 54b. When the media rollers 54a, b are both rotated, the thermal print media 32 is pulled upwardly towards a media guide 56. The upper sheet input image material tray 50b includes an upper media lift cam 52b for lifting the upper sheet thermal print material tray 50b and, ultimately, the thermal print media 32 towards the upper media roller 54b, which directs it toward the media guide 56.

Continuing with FIG. 1, the movable media guide 56 directs the thermal print media 32 under a pair of media guide rollers 58. This engages the thermal print media 32 for assisting the upper media roller 54b in directing the thermal print media 32 onto the media staging tray 60. The media guide 56 is attached and hinged to the lathe bed scanning frame 202 at one end, and is uninhibited at its other end for permitting multiple positioning of the media guide 56. The media guide 56 then rotates the uninhibited end downwardly, as illustrated. The direction of rotation of the upper media roller 54b is reversed for moving the thermal print medium receiver sheet material 32, which is resting on the media staging tray 60, under the pair of media guide rollers 58 upwardly through an entrance passageway 204 and up to an imaging drum 300. Typically the drum is a cylindrical drum although other suitable shapes of drum may be used. For example, the drum may be octagonal, amongst other possible shapes.

A roll 30 of dye donor material 34 is connected to the media carousel 100 in a lower portion of the image processor housing 12, as shown in FIG. 1. Four rolls 30 are ordinarily used, but, for clarity, only one is shown in FIG. 1. Each roll 30 includes a dye donor material 34 of a different color, typically black, yellow, magenta and cyan. These dye donor materials 34 are ultimately cut into dye donor sheet materials and passed to the imaging drum 300 for forming the medium from which dyes embedded therein are passed to the thermal print media 32 resting thereon. In this regard, a media drive mechanism 110 is attached to each roll 30 of dye donor material 34, and includes three media drive rollers 112 through which the dye donor material 34 of interest is metered upwardly into a media knife assembly 120. After the dye donor material 34 reaches a predetermined position, the media drive rollers 112 cease driving the dye donor material 34. Two media knife blades 122 positioned at the bottom portion of the media knife assembly 120 cut the dye donor material 34 into dye donor sheet materials. The lower media roller 54a and the upper media roller 54b along with the media guide 56 then pass the dye donor sheet material onto the media staging tray 60 and ultimately to the imaging drum 300.

Although not shown, the apparatus in FIG. 1 may optionally include and a magnetic load roller. Once the thermal print medium receiver sheet material 32 is moved into position, the magnetic load roller is moved into contact with the thermal print medium receiver sheet material 32 against the imaging drum 300. The imaging drum 300 would be provided with a ferrous coating that attracts the magnetic load roller to it, with the magnetic load roller aligning itself to the imaging drum 300.

As shown in FIG. 1, a laser assembly 400 includes a quantity of laser diodes 402 in its interior. The lasers are connected via fiber optic cables 404 to a distribution block 406 and ultimately to a printhead 500. The printhead 500 directs thermal energy received from the laser diodes 402. This causes the dye donor sheet material to pass the desired color across the gap to the thermal print media 32. The printhead 500 attaches to a lead screw (not shown). A lead screw drive nut and drive coupling (not shown) permit axial movement along the longitudinal axis of the imaging drum 300 for transferring the data to create the intended image onto the thermal print media 32.

For writing, the imaging drum 300 rotates at a constant velocity. The printhead 500 begins at one end of the thermal print media 32 and traverses the entire length of the thermal print media 32 for completing the transfer process for the particular dye donor sheet material resting on the thermal print media 32. After the printhead 500 completes the transfer process for the particular dye donor sheet material resting on the thermal print media 32, the dye donor sheet material is removed from the imaging drum 300 and transferred out of the image processor housing 12 via a skive or ejection chute 16. The dye donor sheet material eventually comes to rest in a waste bin 18 for removal by the user. The above-described process is then repeated for the other three rolls 30 of dye donor materials 34.

Continuing with FIG. 1, after the color from all four sheets of the dye donor sheet materials has been transferred, the dye donor sheet material is removed from the imaging drum 300. The thermal print media 32 with the intended image thereon is then removed from the imaging drum 300 and transported via a transport mechanism 80 out of the image processor housing 12 and comes to rest against a media stop 20.

Operation of the image processing apparatus 10 includes metering a length of the thermal print media (in roll form) from the material assembly or carousel. The thermal print media 32 is then measured and cut into sheet form of the required length and transported to the imaging drum 300. It is then registered, wrapped around, and secured onto the drum 300. Next, a length of dye donor material (in roll form) 34 is metered out of the material supply assembly or carousel, measured, and cut into sheet form of the required length. It is then transported to the imaging drum 300 and wrapped around the imaging drum optionally using a magnetic load roller, so that it is superposed in the desired registration with respect to the thermal print media, which has already been secured to the imaging drum.

After the dye donor sheet material is secured to the periphery of the imaging drum 300, the scanning subsystem or write engine provides the scanning function. This is accomplished by retaining the thermal print media 32 and the dye donor sheet material on the spinning imaging drum 300 while it is rotated past the printhead 500 that will expose the thermal print media 32.

Continuing with a description of the operation of the apparatus, the media carousel 100 is rotated about its axis into the desired position, so that the thermal print media 32 or dye donor material (in roll form) 34 can be withdrawn, measured, and cut into sheet form of the required length, and then transported to the imaging drum. To accomplish this, the media carousel 100 has a vertical circular plate, preferably with, though not limited to, six material support spindles. The support spindles are arranged to carry one roll of thermal print media, and four rolls of dye donor material. They provide the four primary colors, which are preferably used in the writing process to form the intended image. One roll is used as a spare or for a specialty color dye donor material, if so desired. Each spindle has a feeder assembly to withdraw the thermal print media or dye donor material from the spindles.

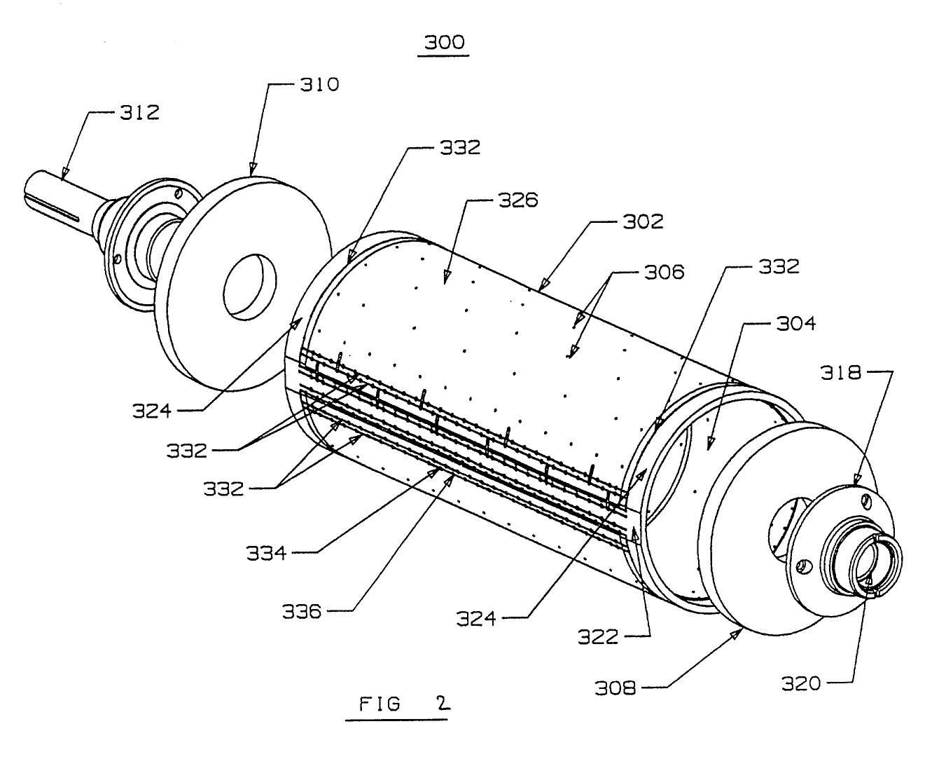

Referring to FIGS. 2 and 3, the imaging drum 300 has a cylindrical-shaped vacuum drum housing 302. The drum is, by definition, hollow, and includes a hollowed-out interior portion 304. The imaging drum 300 further includes a number of vacuum grooves 346 and vacuum holes 306 extending through the vacuum drum housing 302. Vacuum is applied from the hollow interior portion 304 of the imaging drum 300 through these vacuum grooves and holes. The vacuum supports and maintains the position of the thermal print media 32 and the dye donor sheet material, even as the imaging drum 300 rotates.

Continuing with FIG. 2, the ends of the imaging drum 300 are closed by a vacuum end plate 308, and a drive end plate 310. The drive end plate 310 is provided with a centrally disposed drive spindle 312, which extends outwardly therefrom through a support bearing. The vacuum end plate 308 is provided with a centrally disposed vacuum spindle 318, which extends outwardly therefrom through another support bearing.

The drive spindle 312 extends through the support bearing and is stepped down to receive a DC drive motor armature (not shown), which is held on by a drive nut. A DC motor stator (not shown) is stationarily held by the late bed scanning frame member 202 (see FIG. 1), encircling the DC drive motor armature to form a reversible, variable DC drive motor for the imaging drum 300. A drum encoder mounted at the end of the drive spindle 312 provides timing signals to the image processing apparatus 10.

As shown in FIG. 2, the vacuum spindle 318 is provided with a central vacuum opening 320. The central vacuum opening 320 is in alignment with a vacuum fitting with an external flange that is rigidly mounted to the lathe bed scanning frame 202 (see FIG. 1). The vacuum fitting has an extension, which extends within but is closely spaced from the vacuum spindle 318, thus forming a small clearance. With this configuration, a slight vacuum leak is provided between the outer diameter of the vacuum fitting and the inner diameter of the central vacuum opening 320 of the vacuum spindle 318. This assures that no contact exists between the vacuum fitting and the imaging drum 300 that might impart uneven movement or jitters to the imaging drum 300 during its rotation.

The opposite end of the vacuum fitting is connected to a high-volume vacuum blower (not shown), which is capable of producing 50-60 inches of water at an air flow volume of 60-70 CFM. The vacuum blower provides vacuum to the imaging drum 300. The vacuum blower provides the various internal vacuum levels required during loading, scanning and unloading of the thermal print media 32 and the dye donor sheet materials to create the intended image. With no media loaded on the imaging drum 300, the internal vacuum level of the imaging drum 300 is preferably approximately 10-15 inches of water. With just the thermal print media 32 loaded on the imaging drum 300, the internal vacuum level of the imaging drum 300 is preferably approximately 20-25 inches of water. This level is desired so that when a dye donor sheet material is removed, the thermal print media 32 does not move and color to color registration is maintained. With both the thermal print media 32 and dye donor sheet material completely loaded on the imaging drum 300, the internal vacuum level of the imaging drum 300 is approximately 50-60 inches of water in this embodiment.

In operation, vacuum is applied through the vacuum holes 306 extending through the drum housing 302. The vacuum supports and maintains the position of the thermal print media 32 and dye donor sheet material as the imaging drum 300 rotates. The ends of the imaging drum are preferably enclosed by the cylindrical end plates, which are each provided with a centrally disposed spindle 318. The spindles extend outwardly through support bearings and are supported by the scanning frame. The drive end spindle extends through the support bearing and is stepped down to receive the motor armature, which is held on by a nut. The stator is held by the scanning frame, which encircles the armature to form the reversible, variable speed DC drive motor for the imaging drum. An encoder mounted at the end of the spindle provides timing signals to the image processing apparatus. The central vacuum opening 320 on the opposite spindle 318 is in alignment with a vacuum fitting with an external flange that is rigidly mounted to the lathe bed scanning frame 202. The vacuum fitting has an extension extending within the vacuum spindle and forming a small clearance. A slight vacuum leak between the outer diameter of the vacuum fitting and the inner diameter of the opening of the vacuum spindle assures that no contact exists between the vacuum fitting and the imaging drum, which might impart uneven movement or jitters to the drum during its rotation.

In the example shown, the outer surface of the drum 300 is provided with an axially extending flat 322, which preferably extends approximately 8 degrees of the drum 300 circumference. The drum 300 is provided with donor support rings 324, which form a recess 326. As will be explained below, the donor support rings 324 are formed by a mask applied to the surface of the drum 300. This recess extends radially from one side of the axially extending flat 322 around the drum 300 to the other side of the axially extending flat 322, from approximately one inch from one end of the drum 300 to approximately one inch from the other end of the drum 300.

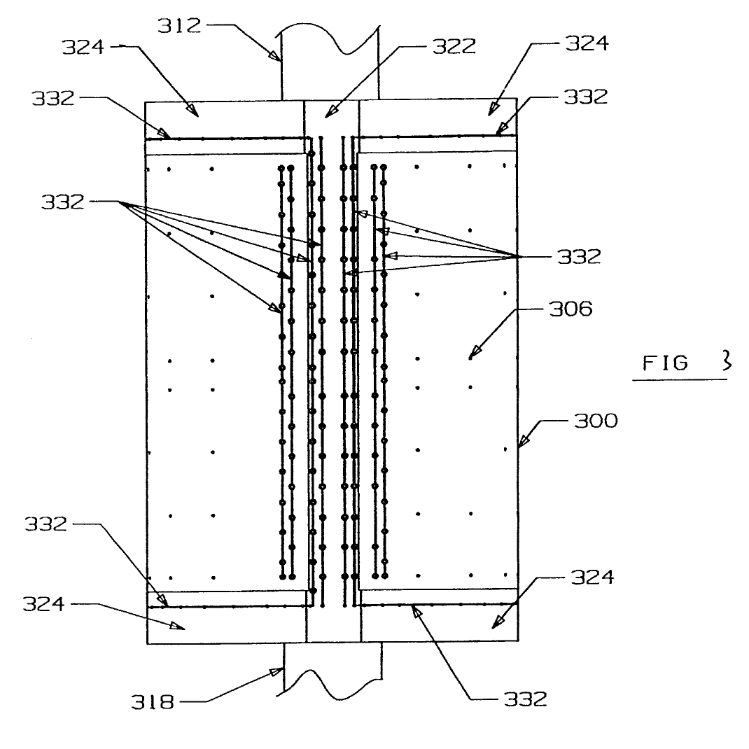

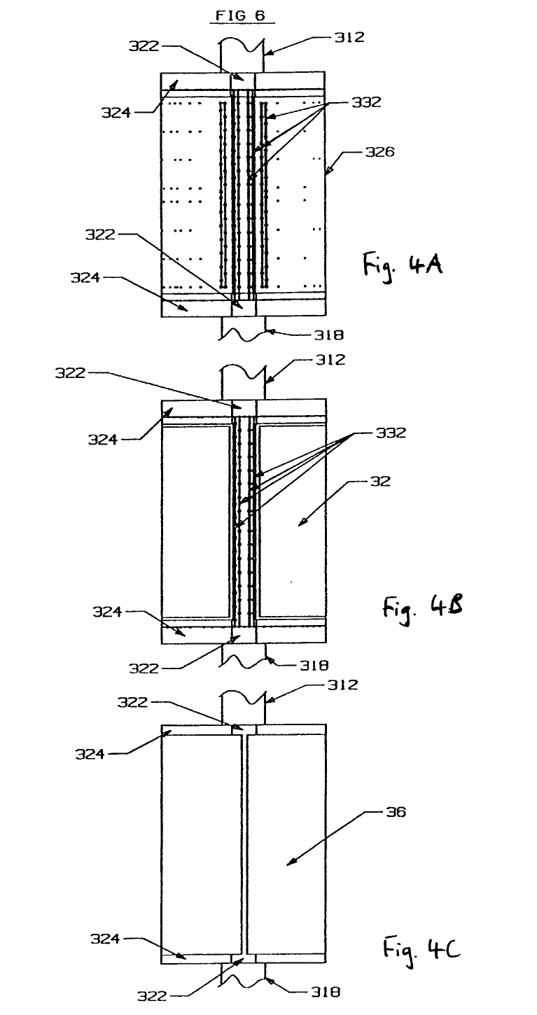

As shown in FIGS. 4A through 4C, the thermal print media 32 when mounted on the drum 300 is seated within the radial recess 326. Therefore, the donor support rings 324 have a thickness which is substantially equal to the thickness of the thermal print media 32 seated therebetween. In this embodiment, this thickness is 0.004 inches. The purpose of the radial recess 326 on the drum 300 surface is to eliminate any creases in the dye donor sheet material, as the materials are drawn down over the thermal print media 32 during the loading of the dye donor sheet material. This ensures that no folds or creases will be generated in the dye donor sheet material, which could extend into the image area and seriously adversely affect the intended image. The radial recess 326 also substantially eliminates the entrapment of air along the edge of the thermal print media 32, since the vacuum holes 306 in the drum 300 surface cannot always ensure the removal of the entrapped air. Any residual air between the thermal print media 32 and the dye donor sheet material can also adversely affect the intended image.

FIGS. 5A to 5C are plan views of masks according to one aspect of the present invention. Referring to FIG. 5A, the mask has a substantially rectangular frame having dimensions x and y surrounding a large rectangular opening 340. One dimension, x, is equal in length to the length of the drum to which it is to be applied and the other dimension, y, is equal in length to the circumference of the drum to which it is to be applied. Accordingly, when the mask is applied to a drum, it will define a radial recess on the surface of the drum suitable for receiving sheets of donor and print media. The depth of the axial recess on the drum is defined by the thickness of the mask.

The mask is preferably formed of a material selected from the group consisting of polyurethane, vinyl, acetate or metallic film. Any suitable alternative may be used. The material must be sufficiently flexible to enable it, in use, to conform to the surface of the drum. A layer of adhesive (not shown) is provided on a surface of the mask which is arranged to contact the drum. This ensures that the mask adheres easily to the drum. Prior to application of the mask to the drum a releasable cover, e.g. a silicone coated cover, may be provided on the adhesive so that the mask is easily handled.

One or more vent holes 342 are provided in the mask to enable communication between the vacuum within the drum and a layer of material applied on the mask. In other words, when a sheet of colorant donor material is arranged on the drum, the configuration of the venting holes in the mask ensure that the colorant donor material can be held in position. As shown in FIG. 5C, any suitable configuration for the vent holes may be used. In this case shown in FIG. 5C, vent strips 344 are provided.

FIG. 5B shows an alternative configuration for the mask. In this case the mask is U-shaped. When in place, arranged on the drum surface, the parallel arms of the U-shaped mask will wrap around the drum such that the effective shape of the mask on the drum will be substantially the same as that of the masks in FIGS. 5A and 5C. The mask may also comprise two elongate strips of material for positioning at opposite ends of the drum. By wrapping the strips radially around the ends of the drum a recess is defined between them along the length of the drum.

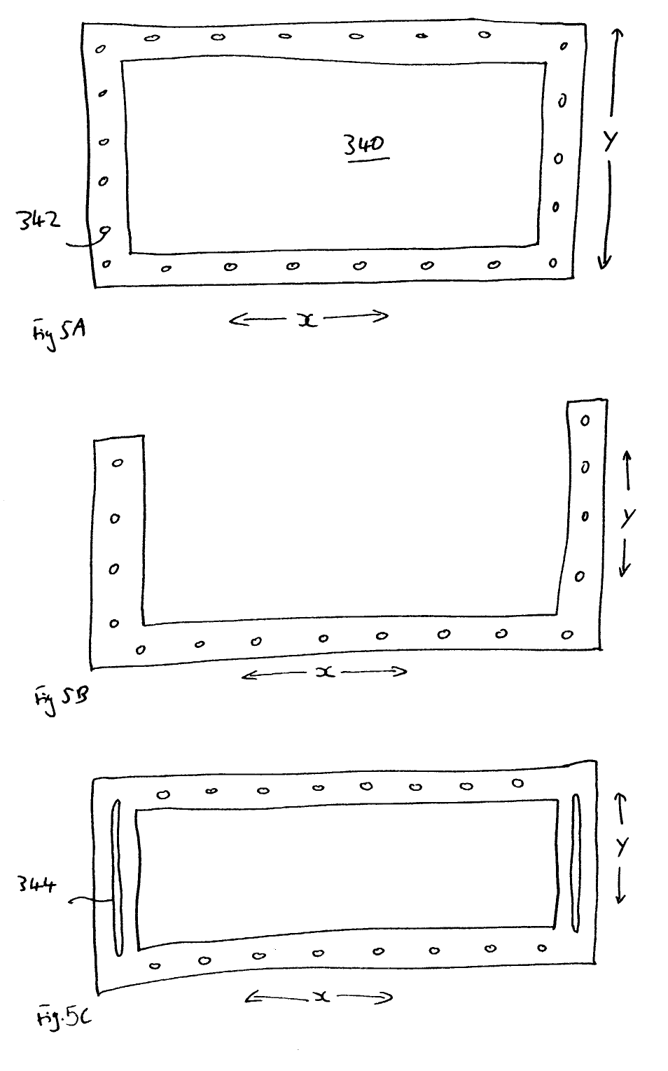

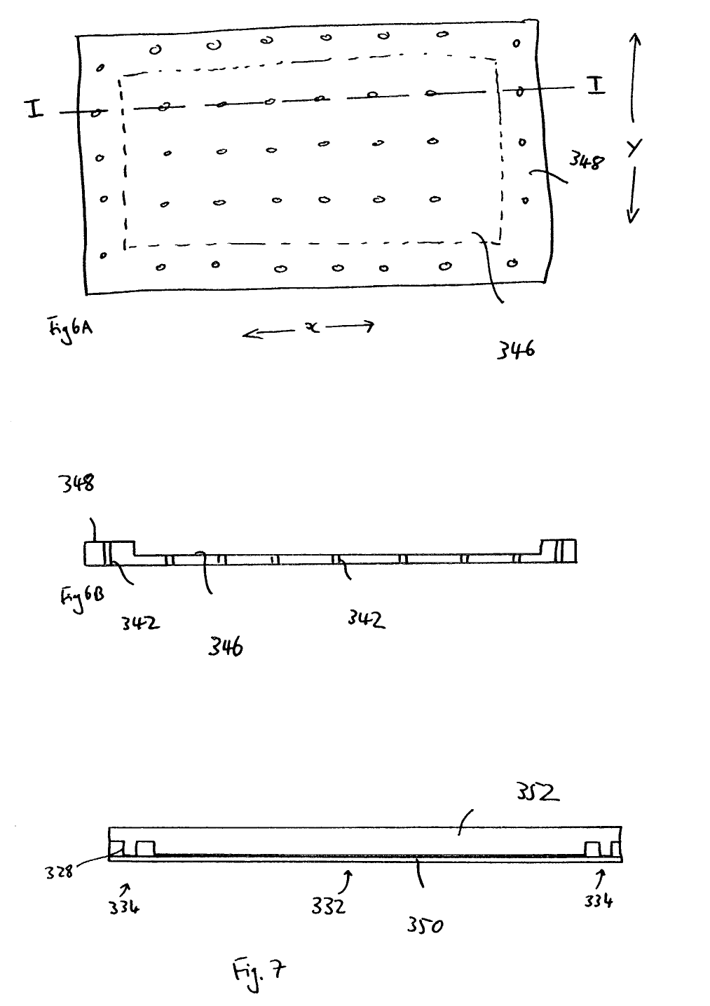

FIG. 6A shows an alternative example of a mask according to the present invention and FIG. 6B shows a section through the line II in the mask of FIG. 6A. In this case there is no large rectangular opening 340 as in the examples shown in FIGS. 5A to 5C. Rather, the mask is a planar sheet of material having a central region 346, surrounded by a frame region 348. The central region 346 is thinner than the frame region 348 (see FIG. 6B), such that when the mask is arranged on a drum, a radial recess is defined. In this case, the depth of the axial recess is defined by the difference between the respective thickness of each of regions 346 and 348. Vent holes are provided in both the central region 346 and the frame region 348 so that the thermal print media can be secured in position by interaction with vacuum from within the drum.

In the examples shown in FIGS. 5A to 5C and 6A and 6B, the depth of the recess formed when the mask is applied to a drum is defined by the difference in thickness between the central regions and frame regions of the masks. It is preferred that this is approximately equal to the thickness of the thermal print media. Typically, this may be from 60 μm to 280 μm.

As explained above, a layer of adhesive (not shown) is provided on a surface of the mask which is arranged to contact the drum. This ensures that the mask adheres easily to the drum. Prior to application of the mask to the drum a releasable cover, e.g. a silicone coated cover, may be provided on the adhesive so that the mask is easily handled. FIG. 7 shows a section through a mask according to the present invention, prior to application to a drum. As above the mask comprises regions 346 and 348 that define a recess when the mask is arranged on a drum. In addition, a cover 350 is shown that serves to cover adhesive on the mask prior to application to a drum. A liner 352 is also provided. The liner 352 serves to simplify the process of application of the mask to the drum.

To apply the mask to the drum, first the silicone-coated cover 350 is removed and the remaining structure is applied to the drum. Once this has been done, the liner 352 is removed leaving the mask positioned correctly on the drum.

### Parts List

10 Image processing apparatus

12 Image processor housing

14 Image processor door

16 Skive or ejection chute

18 Waste bin

20 Media stop

30 Roll

34 Dye donor material

32 Thermal print media

50 Sheet material tray

50a Lower sheet tray

50b Upper sheet tray

52a Lower media lift cam

52b Upper media lift cam

54a Lower media roller

54b Upper media roller

56 Media guide

58 Media guide rollers

60 Media staging tray

80 Transport mechanism

100 Media carousel

110 Media drive mechanism

112 Media drive rollers

120 Knife assembly

122 Knife blades

202 Lathe bed scanning frame

204 Entrance passageway

300 Imaging drum

302 Vacuum drum housing

304 Hollow interior portion

306 Vacuum holes

308 Vacuum end plate

310 Drive end plate

312 Drive spindle

318 Vacuum spindle

320 Central vacuum opening

322 Axially extending flat

324 Donor support rings

326 Radial recess

336 Vacuum grooves

340 Opening

342 Vent holes

344 Vent strips

346 Central region

348 Frame region

350 Cover

352 Liner

400 Laser assembly

402 Laser diodes

404 Fiber optic cable

406 Distribution block

500 Printhead

What is claimed is:

1. An imaging drum for an imaging apparatus, wherein said imaging drum is provided with a recess for receiving an image media, the recess being defined by one or more openings of a mask coupled to the drum.

2. A drum according to claim 1, in which the drum is cylindrical and the recess is a radial recess.

3. A drum according to claim 1, in which the mask is a substantially rectangular frame.

4. A kit for assembling an imaging drum, the kit comprising:
a drum; and
a mask formed of a material having a thickness sufficient to define the desired depth of a recess formed on the drum when said mask is applied to the drum.

5. A kit according to claim 4, in which the mask is formed from material having one side coated with adhesive such that the mask is easily adhered to the drum.

6. A kit according to claim 4, in which the mask is formed of a material selected from the group consisting of polyurethane, vinyl, acetate, metallic film or any other suitable material.

7. A kit according to claim 6, in which the mask comprises two elongate rectangular members, for positioning around and at opposite ends of the drum, thereby defining a recess therebetween.

8. A kit according to claim 6, in which the mask comprises a sheet of said material having a recessed rectangular portion.

9. A kit according to claim 6, in which one or more vent holes are provided in the mask to enable communication between the drum and a layer of material applied on the mask.

10. A mask for application to an imaging drum, wherein when said mask is applied to an imaging drum a recess is defined on the drum surface, and wherein the thickness of the mask is selected to correspond to the desired depth of the recess.

11. A mask according to claim 10, the mask being formed of a material selected from the group consisting of polyurethane, vinyl, acetate, metallic film or any other suitable material.

12. A mask according to claim 11, for application to a cylindrical drum, comprising a substantially rectangular frame having one dimension equal in length to the length of the drum to which it is to be applied and one dimension equal in length to the circumference of the drum to which it is to be applied.

13. A mask according to claim 11, comprising a sheet of said material having a recessed rectangular portion, the recessed rectangular portion defining a recess on the drum surface when the mask is applied to an imaging drum.

14. A mask according to claim 13, in which one or more vent holes are provided in the sheet to enable communication between the drum and a layer of material applied on top of the mask with respect to the drum.

15. A mask according to claim 11, comprising a pressure sensitive adhesive on one side thereof to enable adherence of said mask to the drum.

16. An imaging apparatus, comprising an imaging drum according to claim 1, for receiving thermal print media and at least one colorant donor material; and,
a writer to write an image onto the thermal print media.

17. A method of making an imaging drum for use in an imaging apparatus, comprising the steps of:
providing a drum; and
applying a mask to the drum, the mask pattern being formed of a material having a thickness sufficient to define a recess of a desired depth on the drum surface when said mask is applied to the drum.
